(19) United States
(12) Patent Application Publication
(10) Pub. No.: US 2010/0135036 A1
(43) Pub. Date: Jun. 3, 2010

(54) VEHICLE LIGHTING DEVICE

(75) Inventors: Yoshiaki Matsuba, Imabari-shi (JP); Yuji Wagatsuma, Imabari-shi (JP); Takeo Kato, Imabari-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: HARISON TOSHIBA LIGHTING Corp., Imabari-shi (JP)

(21) Appl. No.: 12/565,345

(22) Filed: Sep. 23, 2009

(30) Foreign Application Priority Data
Dec. 2, 2008 (JP) 2008-307886
Mar. 9, 2009 (JP) 2009-055378

(51) Int. Cl. B60Q 1/04; B60Q 1/00

(52) U.S. Cl. 362/516; 362/507

(57) ABSTRACT

An optical axis O′ of a lens section of an optical member is inclined downward relative to a horizontal direction (an optical axis O of each LED) from a light emitting section of each LED. Therefore, an area at and below a horizontal position of a lighting device is illuminated by the lens section while each LED is arranged at an optically ideal position relative to the lens section. Also, reflection surfaces of upper and lower reflector sections and of the optical member are respectively set based on parabolas P1 and P2 different from each other with focal points F1 and F2 positioned at each LED. Therefore, the area at and below the horizontal position of the lighting device is illuminated respectively by the reflector sections while each LED is arranged at an optically ideal position relative to the reflector sections.

### CROSS-REFERENCE TO RELATED APPLICATIONS

This application is based upon and claims the benefit of priority from the prior Japanese Patent Application No. 2008-307886 filed in Japan on Dec. 2, 2008 and Japanese Patent Application No. 2009-055378 filed in Japan on Mar. 9, 2009; the entire contents of which are incorporated herein by reference.

### BACKGROUND OF THE INVENTION

1. Field of the Invention

The present invention relates to a vehicle lighting device configured to illuminate a preset illumination area with predetermined light distribution.

2. Description of Related Art

Light emitting diodes (LEDs) typically have an advantage that the LEDs consume less electricity and have a long operating life. In recent years, as LEDs have higher output, LEDs are expected to be applied as a light source of a lighting device, such as a headlamp and fog lamp mounted on a vehicle, in which a higher light intensity is required, for example.

Meanwhile, in the vehicle lighting device such as a headlamp and fog lamp, a light distribution pattern of emitted light is determined by standards. As a technique for achieving the light distribution pattern, for example, Japanese Patent Application Laid-Open Publication No. 2006-164923 discloses a technique in which a vehicle lighting fixture (a vehicle lighting device) is composed of a linear light source in which a plurality of LEDs are arranged linearly, and a prism lens provided continuously to the linear light source, a columnar member whose upper surface and lower surface are formed along a single parabola and which extends in a fan shape in section constitutes a body portion of the prism lens, a direct light emitting section having a convex curved shape in section is formed in a longitudinal direction of the body portion at a center portion in a width direction of the body portion, and a first reflected light emitting section and a second reflected light emitting section are respectively formed on an upper side and a lower side of the direct light emitting section. In the vehicle lighting fixture, the light source is offset relative to a focal point of the parabola that defines the upper and lower reflection surfaces and an optical axis of the direct light emitting section, and inclination angles of the first and second reflected light emitting sections are adjusted. An illumination pattern of predetermined light distribution is thereby projected onto an area below a horizontal axis as determined by regulations.

In the technique disclosed in Japanese Patent Application Laid-Open Publication No. 2006-164923, however, the illumination pattern may have lower sharpness since the desired light distribution is achieved by offsetting the light source from an ideal position thereof with respect to each functional section of the prism lens.

In the technique disclosed in Japanese Patent Application Laid-Open Publication No. 2006-164923, both end portions of the illumination pattern formed by the prism lens may expand in an upward and downward direction. The phenomenon is believed to occur because light diffused over a wide angle in a longitudinal direction from the LED cannot be sufficiently controlled by the prism lens. When the both end portions of the illumination pattern expand in the upward and downward direction, the light distribution pattern required in the vehicle lighting fixture may not be achieved, or visibility may be deteriorated due to unnecessary light especially by the expansion in the upward direction.

It is an object of the present invention to provide a vehicle lighting device capable of appropriately projecting an illumination pattern of desired light distribution.

### BRIEF SUMMARY OF THE INVENTION

A vehicle lighting device according to the present invention includes a light source whose optical axis is set in a horizontal direction, and an optical member configured to control emitted light from the light source, wherein the optical member includes: a lens section provided on the optical axis of the light source and configured to emit incident light from the light source by changing the incident light by refraction; an upper reflector section integrated with the lens section and made of a light transmissive material, and configured to emit incident light from the light source by totally reflecting the incident light at an upper reflection surface formed above the lens section; and a lower reflector section integrated with the lens section and made of a light transmissive material, and configured to emit incident light from the light source by totally reflecting the incident light at a lower reflection surface formed below the lens section, an optical axis of the lens section being inclined downward relative to the horizontal direction from the light source, the upper reflection surface being an aspheric surface with a focal point positioned at the light source or vicinity of the light source, and the lower reflection surface being an aspheric surface different from the upper reflection surface with a focal point positioned at the light source or vicinity of the light source.

The above and other objects, features and advantages of the invention will become more clearly understood from the following description referring to the accompanying drawings.

### BRIEF DESCRIPTION OF THE DRAWINGS

FIG. 1 is an exploded perspective view schematically illustrating a configuration of a vehicle lighting device according to a first embodiment of the present invention;

FIG. 2 is a vertical sectional view of a portion of the vehicle lighting device;

FIG. 3 is an explanatory view illustrating an optical axis of a lens section;

FIG. 4 is an explanatory view illustrating a simulation result of behavior of light that enters an optical member;

FIG. 5 is an explanatory view illustrating an illumination pattern when the optical member according to the present invention is used;

FIG. 6 is an exploded perspective view schematically illustrating a configuration of a vehicle lighting device according to a second embodiment of the present invention;

FIG. 7 is a vertical sectional view of a portion of the vehicle lighting device;

FIG. 8 is an explanatory view illustrating an optical axis of a lens section;

FIG. 9 is an explanatory view illustrating a simulation result of behavior of light that enters an optical member;

FIG. 10A is a side view illustrating in detail behavior of light that enters a lower portion of an incident surface of the lens section;

FIG. 10B is a side view illustrating in detail behavior of light that enters the lower portion of the incident surface of the lens section in which a refraction section is not provided;

FIG. 11A is a plan view illustrating in detail behavior of light that enters the lower portion of the incident surface of the lens section;

FIG. 11B is a plan view illustrating behavior of light that enters the lower portion of the incident surface of the lens section in which a refraction section is not provided;

FIG. 12A is a back view illustrating in detail behavior of light that enters the lower portion of the incident surface of the lens section;

FIG. 12B is a back view illustrating behavior of light that enters the lower portion of the incident surface of the lens section in which a refraction section is not provided;

FIG. 13A is an explanatory view illustrating an illumination pattern when the optical member according to the present invention is used;

FIG. 13B is an explanatory view illustrating an illumination pattern when the optical member in which the refraction section is not provided in the lower portion of the incident surface of the lens section is used;

FIG. 14 is an exploded perspective view schematically illustrating a configuration of a vehicle lighting device according to a third embodiment of the present invention;

FIG. 15 is a vertical sectional view of a portion of the vehicle lighting device;

FIG. 16 is a horizontal sectional view of the portion of the vehicle lighting device;

FIG. 17 is an explanatory view illustrating a simulation result of behavior of light that enters the optical member; and

FIG. 18 is a vertical sectional view of the portion illustrating a modification of the vehicle lighting device.

### DETAILED DESCRIPTION OF THE INVENTION

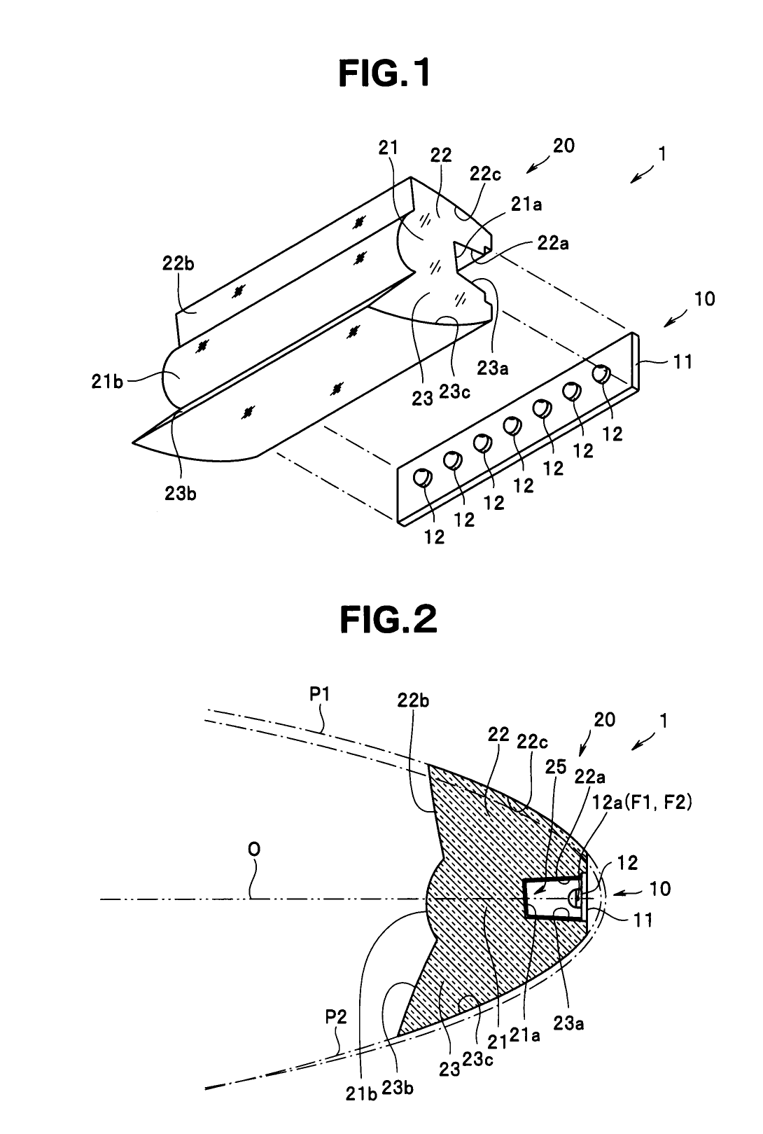

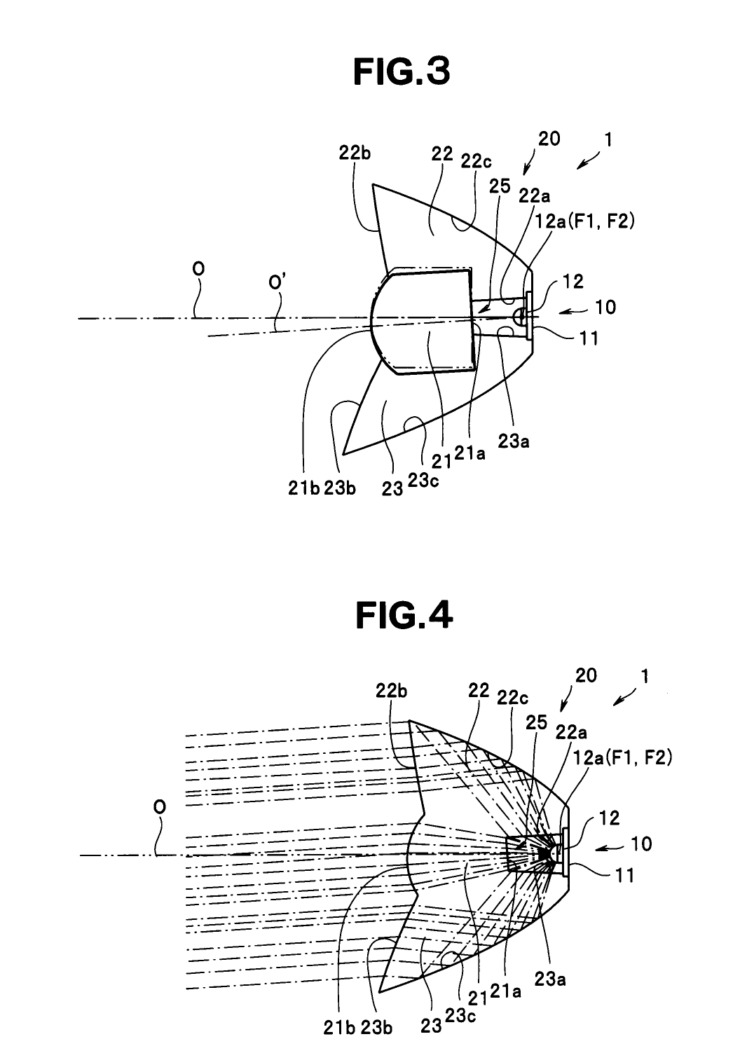

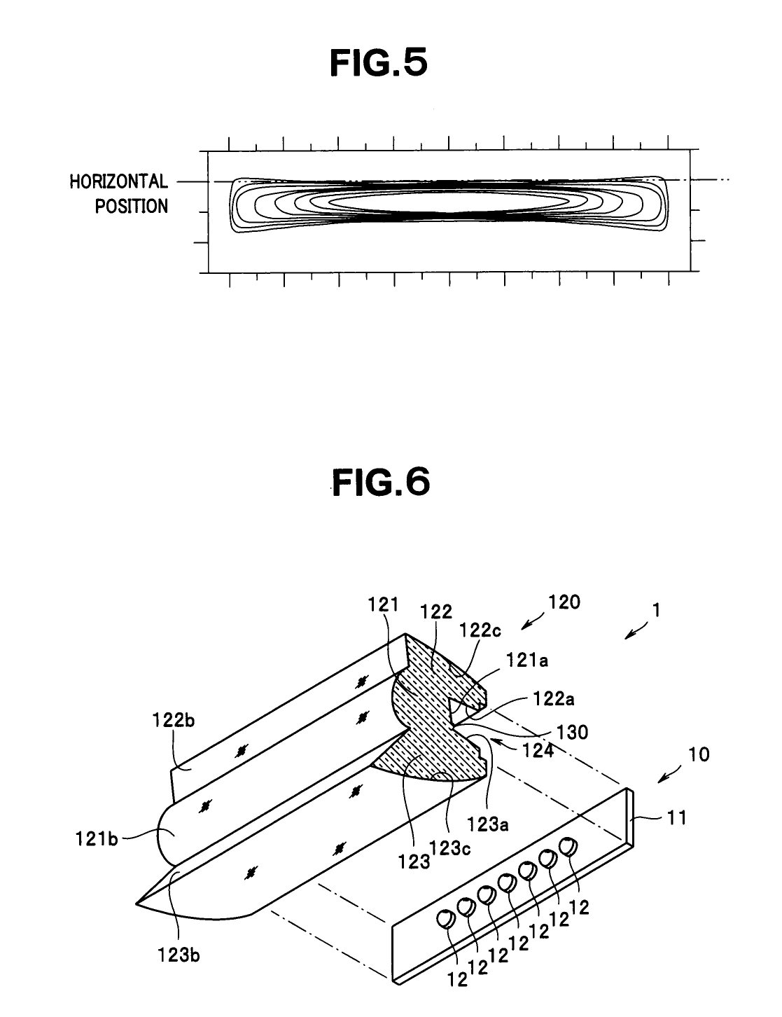

In the following, embodiments of the present invention will be described with reference to the drawings. FIGS. 1 to 5 are related to a first embodiment of the present invention. FIG. 1 is an exploded perspective view schematically illustrating a configuration of a vehicle lighting device. FIG. 2 is a vertical sectional view illustrating a portion of the vehicle lighting device. FIG. 3 is an explanatory view illustrating an optical axis of a lens section. FIG. 4 is an explanatory view illustrating a simulation result of behavior of light that enters an optical member. FIG. 5 is an explanatory view illustrating an illumination pattern when the optical member according to the present invention is used.

In FIGS. 1 and 2, reference numeral 1 denotes a vehicle lighting device, and in the present embodiment, specifically denotes a vehicle fog lamp. The lighting device 1 includes a light source unit 10 having a plurality of light emitting diodes (LEDs) 12 as a light source, and an optical member 20 configured to control emitted light from each of the LEDs 12 of the light source unit 10. The light source unit 10 and the optical member 20 are housed in a housing (not shown).

The light source unit 10 includes an LED substrate 11 having a long planar substantially-rectangular shape, for example. The plurality of (for example, 7) LEDs 12 is mounted on a mounting surface of the LED substrate 11. In the present embodiment, each of the LEDs 12 is a surface-mount LED having a lens with one convex surface fixed to its emission surface side. The LEDs 12 are arranged in a line in a longitudinal direction of the LED substrate 11. When the lighting device 1 is mounted on a vehicle, the LED substrate 11 is disposed in an erect state with the mounting surface being directed toward a vehicle front such that its long sides extend in a vehicle width direction and its short sides extend in an upward and downward direction. Accordingly, the LEDs 12 are arranged in a line in the vehicle width direction, and an optical axis O of each of the LEDs 12 is set toward the front in a horizontal direction. In the present invention, the horizontal direction in which the optical axis O of each of the LEDs 12 or the like is set is not required to be exactly horizontal, but a predetermined angle of inclination may be tolerated.

The optical member 20 includes a lens section 21 provided on the optical axis O of each of the LEDs 12 and configured to emit incident light from each of the LEDs 12 by changing the direction of the incident light by refraction, an upper reflector section 22 integrated with the lens section 21 and made of a light transmissive material, and configured to emit incident light from each of the LEDs 12 by totally reflecting the incident light above the lens section 21, and a lower reflector section 23 integrated with the lens section 21 and made of a light transmissive material, and configured to emit incident light from each of the LEDs 12 by totally reflecting the incident light below the lens section 21.

As shown in FIGS. 2 and 3, an incident surface 21a of the lens section 21 is a substantially rectangular plane which extends in the longitudinal direction of the LED substrate 11, for example. The incident surface 21a is disposed in an erect state so as to be substantially opposed to each of the LEDs 12 on each of the optical axes O. An emission surface 21b of the lens section 21 is a cylindrical lens surface which extends in the longitudinal direction of the LED substrate 11, for example. The emission surface 21b is opposed to the incident surface 21a. As shown in FIG. 3, an optical axis O′ of the lens section 21 is set to be inclined downward at a predetermined angle relative to the horizontal direction (the optical axis O of each of the LEDs 12) from a light emitting section 12a of each of the LEDs 12. A curvature of the emission surface 21b, an inclination angle of the optical axis O′ of the lens section 21 or the like are respectively determined as desired based on experiments, simulations or the like. Accordingly, as shown in FIG. 4, for example, the lens section 21 mainly allows light radiated at a predetermined radiation angle or less in the upward and downward direction relative to the optical axis O out of the emitted light from each of the LEDs 12 to enter the incident surface 21a. The lens section 21 emits the light by changing the radiation angle in the vertical direction such that the light can be or closer to collimated light by refraction at the incident surface 21a and the emission surface 21b while maintaining a radiation angle in the vehicle width direction at a predetermined angle. The emitted light from the lens section 21 is directed obliquely downward toward the vehicle front by the inclination of the optical axis O′. The emitted light illuminates an area at and below a horizontal position (at and below the optical axis O) of the lighting device 1 at a projection distance of 10 m or more, for example.

As shown in FIGS. 2 and 3, an incident surface 22a of the upper reflector section 22 is a substantially rectangular plane which extends in the longitudinal direction of the LED substrate 11, for example. The incident surface 22a is disposed above each of the LEDs 12 in a collapsed state such that its front end edge portion is provided continuously to an upper end edge portion of the incident surface 21a of the lens section 21 and its proximal end edge portion is in abutment with the LED substrate 11. An emission surface 22b of the upper reflector section 22 is a gentle surface which extends in a short direction of the LED substrate 11, for example. The emission surface 22b is disposed in an erect state by being inclined at a predetermined angle relative to a vertical direction such that its lower end edge portion is provided continuously to an upper end edge portion of the emission surface 21b of the lens section 21. An upper surface of the upper reflector section 22 is formed as a reflection surface (an upper reflection surface) 22c configured to totally reflect and guide incident light from the incident surface 22a toward the emission surface 22b (the vehicle front). The upper reflection surface 22c is an aspheric surface which has a sectional shape along a curved line having a focal point F1 at the light emitting section 12a of each of the LEDs 12 or the vicinity thereof and extends in the longitudinal direction of the LED substrate 11. A front end edge portion of the upper reflection surface 22c is provided continuously to an upper end edge portion of the emission surface 22b. In the present embodiment, the upper reflection surface 22c is a parabolic surface which has a sectional shape along a parabola P1 having a focal point F1 at the light emitting section 12a of each of the LEDs 12 and extends in the longitudinal direction of the LED substrate 11, for example. A shape of the parabola P1 that defines the upper reflection surface 22c, a shape and inclination angle of the emission surface 22b or the like are respectively determined as desired based on experiments, simulations or the like. Accordingly, as shown in FIG. 4, for example, the upper reflector section 22 mainly allows light radiated at a predetermined radiation angle or more in the upward direction relative to the optical axis O out of the emitted light from each of the LEDs 12 to enter the incident surface 22a. The upper reflector section 22 emits the light by changing the radiation angle in the vertical direction such that the light can be or closer to collimated light by refraction at the incident surface 22a and the emission surface 22b, total reflection at the upper reflection surface 22c or the like while maintaining a radiation angle in the vehicle width direction at a predetermined angle. The emitted light from the upper reflector section 22 is directed obliquely downward toward the vehicle front by the shape of the upper reflection surface 22c, the inclination of the emission surface 22b or the like. The emitted light illuminates the area at and below the horizontal position (at and below the optical axis O) of the lighting device 1 at a projection distance of 10 m or more, for example.

As shown in FIGS. 2 and 3, an incident surface 23a of the lower reflector section 23 is a substantially rectangular plane which extends in the longitudinal direction of the LED substrate 11, for example. The incident surface 23a is disposed below each of the LEDs 12 in a collapsed state such that its front end edge portion is provided continuously to a lower end edge portion of the incident surface 21a of the lens section 21 and its proximal end edge portion is in abutment with the LED substrate 11. An emission surface 23b of the lower reflector section 23 is a gentle surface which extends in the short direction of the LED substrate 11, for example. The emission surface 23b is disposed in an erect state by being inclined at a predetermined angle relative to the vertical direction such that its upper end edge portion is provided continuously to a lower end edge portion of the emission surface 21b of the lens section 21. A lower surface of the lower reflector section 23 is formed as a reflection surface (a lower reflection surface) 23c configured to totally reflect and guide incident light from the incident surface 23a toward the emission surface 23b (toward the vehicle front). The lower reflection surface 23c is an aspheric surface which has a sectional shape along a curved line having a focal point F2 at the light emitting section 12a of each of the LEDs 12 or the vicinity thereof and extends in the longitudinal direction of the LED substrate 11. A front end edge portion of the lower reflection surface 23c is provided continuously to a lower end edge portion of the emission surface 23b. In the present embodiment, the lower reflection surface 23c is a parabolic surface which has a sectional shape along a parabola P2 having a focal point F2 at the light emitting section 12a of each of the LEDs 12 and extends in the longitudinal direction of the LED substrate 11, for example. The lower reflection surface 23c is a reflection surface whose contour is different from that of the upper reflection surface 22c. That is, a different parabola from the parabola P1 that defines the upper reflection surface 22c is set as the parabola P2 that defines the lower reflection surface 23c as shown in FIG. 2. A shape of the parabola P2 that defines the lower reflection surface 23c, a shape and inclination angle of the emission surface 23b or the like are respectively determined as desired based on experiments, simulations or the like. Accordingly, as shown in FIG. 4, for example, the lower reflector section 23 mainly allows light radiated at a predetermined radiation angle or more in the downward direction relative to the optical axis O out of the emitted light from each of the LEDs 12 to enter the incident surface 23a. The lower reflector section 23 emits the light by changing the radiation angle in the vertical direction such that the light can be or closer to collimated light by refraction at the incident surface 23a and the emission surface 23b, total reflection at the lower reflection surface 23c or the like while maintaining a radiation angle in the vehicle width direction at a predetermined angle. The emitted light from the lower reflector section 23 is directed obliquely downward toward the vehicle front by the shape of the lower reflection surface 23c, the inclination of the emission surface 23b or the like. The emitted light illuminates the area at and below the horizontal position (at and below the optical axis O) of the lighting device 1 at a projection distance of 10 m or more, for example.

The incident surfaces 21a, 22a and 23a respectively constituting the lens section 21, the upper reflector section 22, and the lower reflector section 23 define a recessed groove (a recessed line) on a proximal portion side of the optical member 20. The incident surfaces 21a, 22a and 23a, and the LED substrate 11 enclose each of the LEDs 12 at the front, back, top and bottom. Accordingly, the light radiated from each of the LEDs 12 effectively enters the optical member 20 with no leakage. Furthermore, an antireflection layer 25 is formed on each of the incident surfaces 21a, 22a and 23a as shown in FIG. 2. In the present embodiment, the antireflection layer 25 is an antireflection film made of a light transmissive material having a predetermined refractive index. Since the antireflection layer 25 is formed, occurrence of stray light due to a Fresnel reflection component is prevented when the light from each of the LEDs 12 enters the incident surfaces 21a, 22a and 23a. The antireflection layer 25 is not limited to the antireflection film, and may be formed by giving fine concave and convex processing on each of the incident surfaces 21a, 22a and 23a, for example.

In the present embodiment, the optical axis O′ of the lens section 21 of the optical member 20 is inclined downward relative to the horizontal direction (the optical axis O of each of the LEDs 12) from the light emitting section 12a of each of the LEDs 12. In this configuration, the area at and below the horizontal position of the lighting device 1 can be preferably illuminated by the lens section 21 while each of the LEDs 12 is arranged at an optically ideal position relative to the lens section 21. Also, the reflection surfaces 22c and 23c of the upper and lower reflector sections 22 and 23 of the optical member 20 are respectively formed according to the parabolas P1 and P2 different from each other with the focal points F1 and F2 positioned at the LEDs 12. In this configuration, the area at and below the horizontal position of the lighting device 1 can be preferably illuminated respectively by the reflector sections 22 and 23 while each of the LEDs 12 is arranged at an optically ideal position relative to the reflector sections 22 and 23. Accordingly, in the lighting device 1 according to the present embodiment employed as the vehicle fog lamp, the illumination light can be sharply projected in an illumination pattern preferable for the fog lamp, in which light is distributed at and below the horizontal position, as shown in FIG. 5, for example. The focal points F1 and F2 may be set to the vicinity of the light emitting section 12a of each of the LEDs 12 depending on the shapes of the reflection surfaces 22c and 23c.

In this case, since the antireflection layer 25 is formed on each of the incident surfaces 21a, 22a and 23a, the occurrence of stray light or the like due to the Fresnel reflection component can be appropriately prevented. Accordingly, a bright line can be prevented from being produced above and below the illumination pattern by the stray light, thereby achieving a light distribution pattern having high visibility.

Since the antireflection layer 25 is formed, incident efficiency from the LEDs 12 to the optical member 20 is also improved, thereby improving luminance of the illumination pattern.

Visible light reflected at the incident surfaces 21a, 22a and 23a is partially absorbed by the LED substrate 11 or the like and converted to heat. By preventing the Fresnel reflection by the antireflection layer 25, returning light to the LED substrate 11 or the like by reflection can be reduced. Thus, even when the LEDs 12 have higher output, such problems that the LED substrate 11 is excessively heated to damage the optical member 20 or reduce light emission efficiency of the LEDs 12 can be prevented.

Although the example in which the present invention is applied to the fog lamp is described in the aforementioned embodiment, the present invention is not limited thereto. For example, the present invention may be also applied to a headlight or the like.

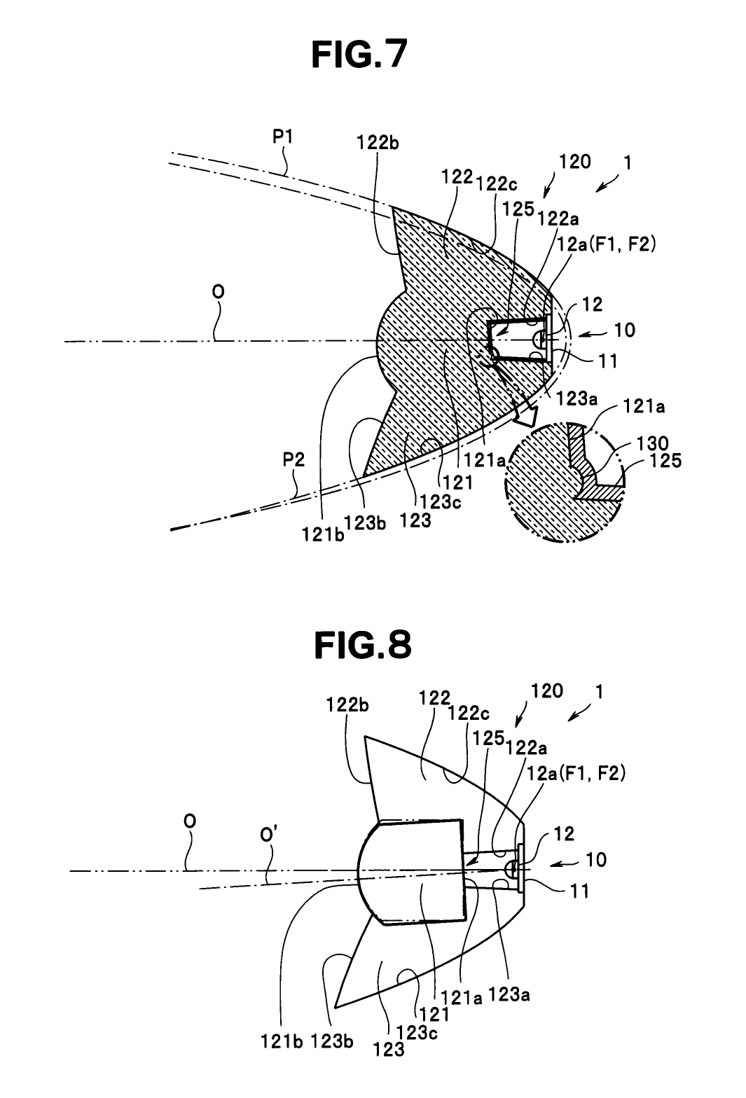

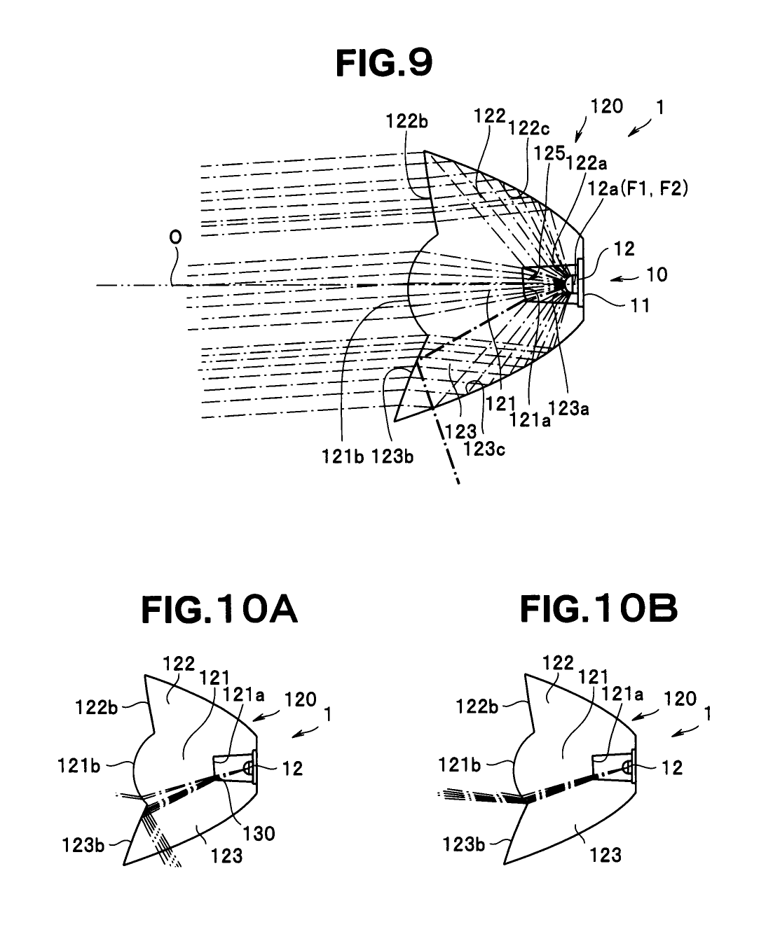

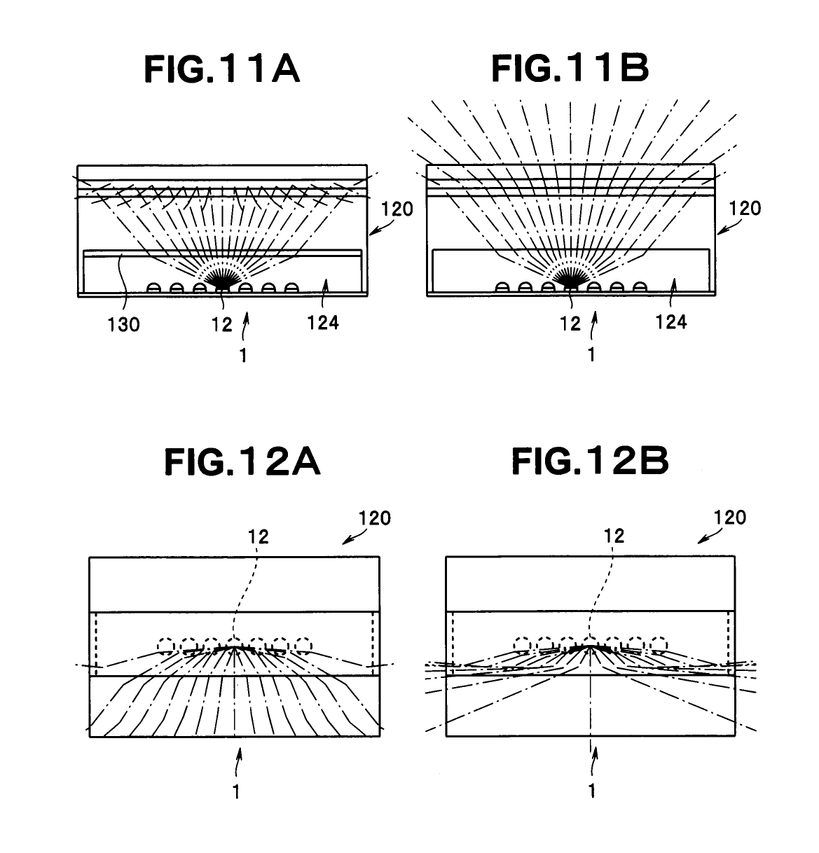

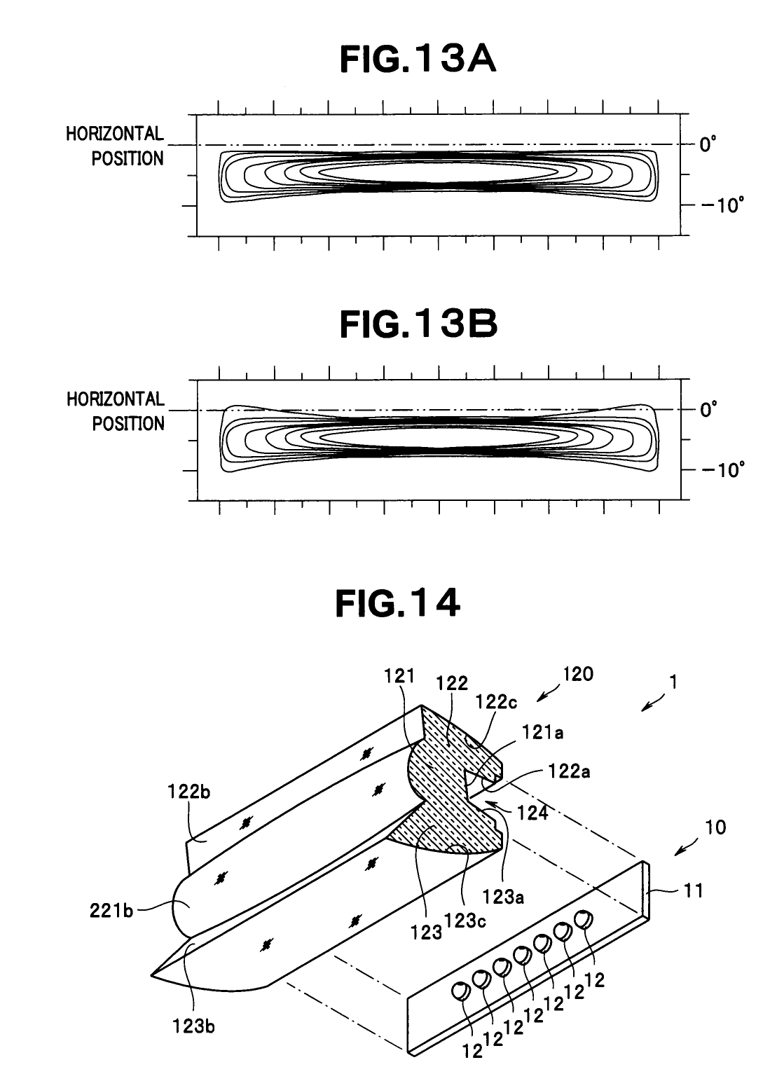

Next, FIGS. 6 to 13B are related to a second embodiment of the present invention. FIG. 6 is an exploded perspective view schematically illustrating a configuration of a vehicle lighting device. FIG. 7 is a vertical sectional view of a portion of the vehicle lighting device. FIG. 8 is an explanatory view illustrating an optical axis of a lens section. FIG. 9 is an explanatory view illustrating a simulation result of behavior of light that enters an optical member. FIG. 10A is a side view illustrating in detail behavior of light that enters a lower portion of an incident surface of the lens section. FIG. 10B is a side view illustrating in detail behavior of light that enters the lower portion of the incident surface of a lens section in which a refraction section is not provided. FIG. 11A is a plan view illustrating in detail behavior of light that enters the lower portion of the incident surface of the lens section. FIG. 11B is a plan view illustrating behavior of light that enters the lower portion of the incident surface of the lens section in which a refraction section is not provided. FIG. 12A is a back view illustrating in detail behavior of light that enters the lower portion of the incident surface of the lens section. FIG. 12B is a back view illustrating behavior of light that enters the lower portion of the incident surface of the lens section in which a refraction section is not provided. FIG. 13A is an explanatory view illustrating an illumination pattern when the optical member according to the present invention is used. FIG. 13B is an explanatory view illustrating an illumination pattern when an optical member in which the refraction section is not provided in the lower portion of the incident surface of the lens section is used. In the present embodiment, the optical member mainly has a different configuration from that of the aforementioned first embodiment. The same or similar components as those of the first embodiment other than the optical member are assigned the same reference numerals, and the description thereof is omitted.

As shown in FIGS. 6 and 7, an optical member 120 according to the present embodiment includes a lens section 121 provided on the optical axis O of each of the LEDs 12 and configured to emit incident light from each of the LEDs 12 by changing the direction of the incident light by refraction, an upper reflector section 122 integrated with the lens section 121 and made of a light transmissive material, and configured to emit incident light from each of the LEDs 12 by reflecting the incident light above the lens section 121, and a lower reflector section 123 integrated with the lens section 121 and made of a light transmissive material, and configured to emit incident light from each of the LEDs 12 by reflecting the incident light below the lens section 121.

As shown in FIGS. 7 and 8, an incident surface 121a of the lens section 121 is a substantially rectangular plane which extends in a longitudinal direction of the LED substrate 11, for example. The incident surface 121a is disposed in an erect state so as to be substantially opposed to each of the LEDs 12 on each of the optical axes O. An emission surface 121b of the lens section 121 is an aspheric cylindrical lens surface which extends in the longitudinal direction of the LED substrate 11, for example. The emission surface 121b is opposed to the incident surface 121a. As shown in FIG. 8, the optical axis O′ of the lens section 121 is set to be inclined downward at a predetermined angle relative to a horizontal direction (the optical axis O of each of the LEDs 12) from the light emitting section 12a of each of the LEDs 12. A curvature of the emission surface 121b, an inclination angle of the optical axis O′ of the lens section 121 or the like are respectively determined as desired based on experiments, simulations or the like. Accordingly, as shown in FIG. 9, for example, the lens section 121 mainly allows light radiated at a predetermined radiation angle or less in the vertical direction relative to the optical axis O out of the emitted light from each of the LEDs 12 to enter the incident surface 121a. The lens section 121 emits the light by changing the radiation angle in the vertical direction such that the light can be or closer to collimated light by refraction at the incident surface 121a and the emission surface 121b while maintaining a radiation angle in a vehicle width direction at a predetermined angle. The emitted light from the lens section 121 is substantially directed obliquely downward toward a vehicle front by the inclination of the optical axis O′. The emitted light illuminates an area at and below a horizontal position (at and below the optical axis O) of the lighting device 1 at a projection distance of 10 m or more, for example.

As shown in FIGS. 7 and 8, an incident surface 122a of the upper reflector section 122 is a substantially rectangular plane which extends in the longitudinal direction of the LED substrate 11, for example. The incident surface 122a is disposed above each of the LEDs 12 in a collapsed state by being inclined at a predetermined angle relative to the horizontal direction such that its front end edge portion is provided continuously to an upper end edge portion of the incident surface 121a of the lens section 121 and its proximal end edge portion is in abutment with the LED substrate 11. An emission surface 122b of the upper reflector section 122 is a gently curved surface which extends in a short direction of the LED substrate 11, for example. The emission surface 122b is disposed in an erect state by being inclined at a predetermined angle relative to a vertical direction such that its lower end edge portion is provided continuously to an upper end edge portion of the emission surface 121b of the lens section 121. An upper surface of the upper reflector section 122 is formed as a reflection surface (an upper reflection surface) 122c configured to reflect and guide incident light from the incident surface 122a toward the emission surface 122b (toward the vehicle front). The upper reflection surface 122c is an aspheric surface which has a sectional shape along a curved line having a focal point F1 at the light emitting section 12a of each of the LEDs 12 or the vicinity thereof and extends in the longitudinal direction of the LED substrate 11. A front end edge portion of the upper reflection surface 122c is provided continuously to an upper end edge portion of the emission surface 122b. In the present embodiment, the upper reflection surface 122c is a parabolic surface which has a sectional shape along the parabola P1 having the focal point F1 at the light emitting section 12a of each of the LEDs 12 and extends in the longitudinal direction of the LED substrate 11, for example. A shape of the parabola P1 that defines the upper reflection surface 122c, a shape and inclination angle of the emission surface 122b or the like are respectively determined as desired based on experiments, simulations or the like. Accordingly, as shown in FIG. 9, for example, the upper reflector section 122 mainly allows light radiated at a predetermined radiation angle or more in the upward direction relative to the optical axis O out of the emitted light from each of the LEDs 12 to enter the incident surface 122a. The upper reflector section 122 emits the light by changing the radiation angle in the vertical direction such that the light can be or closer to collimated light by refraction at the incident surface 122a and the emission surface 122b, total reflection at the upper reflection surface 122c or the like while maintaining a radiation angle in the vehicle width direction at a predetermined angle. The emitted light from the upper reflector section 122 is substantially directed obliquely downward toward the vehicle front by the shape of the upper reflection surface 122c, the inclination of the emission surface 122b or the like. The emitted light illuminates the area at and below the horizontal position (at and below the optical axis O) of the lighting device 1 at a projection distance of 10 m or more, for example.

As shown in FIGS. 7 and 8, an incident surface 123a of the lower reflector section 123 is a substantially rectangular plane which extends in the longitudinal direction of the LED substrate 11, for example. The incident surface 123a is disposed below each of the LEDs 12 in a collapsed state by being inclined at a predetermined angle relative to the horizontal direction such that its front end edge portion is provided continuously to a lower end edge portion of the incident surface 121a of the lens section 121 and its proximal end edge portion is in abutment with the LED substrate 11. An emission surface 123b of the lower reflector section 123 is a gently curved surface which extends in the short direction of the LED substrate 11, for example. The emission surface 123b is disposed in an erect state by being inclined at a predetermined angle relative to the vertical direction such that its upper end edge portion is provided continuously to a lower end edge portion of the emission surface 121b of the lens section 121. A lower surface of the lower reflector section 123 is formed as a reflection surface (a lower reflection surface) 123c configured to reflect and guide incident light from the incident surface 123a toward the emission surface 123b (toward the vehicle front). The lower reflection surface 123c is an aspheric surface which has a sectional shape along a curved line having a focal point F2 at the light emitting section 12a of each of the LEDs 12 or the vicinity thereof and extends in the longitudinal direction of the LED substrate 11. A front end edge portion of the lower reflection surface 123c is provided continuously to a lower end edge portion of the emission surface 123b. In the present embodiment, the lower reflection surface 123c is a parabolic surface which has a sectional shape along the parabola P2 having the focal point F2 at the light emitting section 12a of each of the LEDs 12 and extends in the longitudinal direction of the LED substrate 11, for example. The lower reflection surface 123c is a reflection surface whose contour is different from that of the upper reflection surface 122c. That is, a different parabola from the parabola P1 that defines the upper reflection surface 122c is set as the parabola P2 that defines the lower reflection surface 123c as shown in FIG. 7. A shape of the parabola P2 that defines the lower reflection surface 123c, a shape and inclination angle of the emission surface 123b or the like are respectively determined as desired based on experiments, simulations or the like. Accordingly, as shown in FIG. 9, for example, the lower reflector section 123 mainly allows light radiated at a predetermined radiation angle or more in the downward direction relative to the optical axis O out of the emitted light from each of the LEDs 12 to enter the incident surface 123a. The lower reflector section 123 emits the light by changing the radiation angle in the vertical direction such that the light can be or closer to collimated light by refraction at the incident surface 123a and the emission surface 123b, total reflection at the lower reflection surface 123c or the like while maintaining a radiation angle in the vehicle width direction at a predetermined angle. The emitted light from the lower reflector section 123 is substantially directed obliquely downward toward the vehicle front by the shape of the lower reflection surface 123c, the inclination of the emission surface 123b or the like. The emitted light illuminates the area at and below the horizontal position (at and below the optical axis O) of the lighting device 1 at a projection distance of 10 m or more, for example.

The incident surfaces 121a, 122a and 123a respectively constituting the lens section 121, the upper reflector section 122, and the lower reflector section 123 define a recessed groove (a recessed line) 124 on a proximal portion side of the optical member 120. The incident surfaces 121a, 122a and 123a, and the LED substrate 11 enclose each of the LEDs 12 at the front, back, top and bottom. Accordingly, the light radiated from each of the LEDs 12 effectively enters the optical member 120 with no leakage.

As shown in FIG. 7, a refraction section 130 configured to refract the incident light from each of the LEDs 12 downward and guide the incident light to outside an illumination light path is formed in a lower portion of the incident surface 121a of the lens section 121 inside the recessed groove 124. To be more specific, the refraction section 130 is a projection line which extends in the horizontal direction from one end to the other end of the optical member 120, for example. A curved surface having a predetermined curvature in the vertical direction is formed on a surface of the refraction section 130. The curvature of the surface of the refraction section 130 or the like is optimized in advance based on experiments, simulations or the like. The refraction section 130 guides the incident light on the lower portion of the incident surface 121a into the lower reflector section 123 by refraction, and thereby emits the light from a surface other than the emission surfaces 121b, 122b, and 123b.

Furthermore, an antireflection layer 125 is formed on each of the incident surfaces 121a, 122a and 123a as shown in FIG. 7. In the present embodiment, the antireflection layer 125 is an antireflection film made of a light transmissive material having a predetermined refractive index. Since the antireflection layer 125 is formed, occurrence of stray light due to a Fresnel reflection component is prevented when the light from each of the LEDs 12 enters the incident surfaces 121a, 122a and 123a. The antireflection layer 125 is not limited to the antireflection film, and may be formed by giving fine concave and convex processing on each of the incident surfaces 121a, 122a and 123a, for example.

In the present embodiment, the refraction section 130 configured to refract the incident light from each of the LEDs 12 downward and guide the incident light to outside the illumination light path is provided in the lower portion of the incident surface 121a of the lens section 121. Therefore, an illumination pattern of desired light distribution for in a fog lamp or the like can be appropriately projected.

To be more specific, in the lens section 121 including the cylindrical lens or the like, it is sometimes difficult to appropriately control the light which is radiated at a wide angle in the horizontal direction from each of the LEDs 12 to enter the upper and lower portions of the incident surface 121a. In this case, in the lens section 121 in which the refraction section is not provided in the incident surface 121a, especially the light radiated at a wide angle in the horizontal direction from each of the LEDs 12 to enter the lower portion of the incident surface 121a tends to be emitted from the emission surface 121b in a state of being directed relatively upward relative to the horizontal direction as shown in FIGS. 10B, 11B and 12B, for example. An illumination pattern obtained in this case may not satisfy light distribution or the like determined by regulations because both end portions of the illumination pattern expand in the upward direction as shown in FIG. 13B, for example. On the other hand, in the present embodiment, the refraction section 130 is provided in the lower portion of the incident surface 121a as shown in FIGS. 9, 10A, 11A and 12A, for example. Therefore, the incident light on the lower portion of the incident surface 121a that is difficult to appropriately control by the lens section 121 is refracted downward, and guided to outside the illumination light path. Accordingly, as shown in FIG. 13A, for example, the both end portions of the illumination pattern are prevented from expanding in the upward direction, thereby appropriately satisfying the light distribution or the like determined by regulations. It is also sometimes difficult to control the light incident on the upper portion of the incident surface 121a by the lens section 121. However, since the light causes expansion of the both end portions of the illumination pattern in the downward direction, there occurs no problem from the standpoint of regulations or the like in the vehicle lighting device such as a fog lamp.

The optical axis O′ of the lens section 121 of the optical member 120 is inclined downward relative to the horizontal direction (the optical axis O of each of the LEDs 12) from the light emitting section 12a of each of the LEDs 12. In this configuration, the area at and below the horizontal position of the lighting device 1 can be preferably illuminated by the lens section 121 while each of the LEDs 12 is arranged at an optically ideal position relative to the lens section 121. Also, the reflection surfaces 122c and 123c of the upper and lower reflector sections 122 and 123 of the optical member 120 are respectively formed according to the parabolas P1 ad P2 different from each other with the focal points F1 and F2 positioned at the LEDs 12. Therefore, the area at and below the horizontal position of the lighting device 1 can be preferably illuminated respectively by the reflector sections 122 and 123 while each of the LEDs 12 is arranged at an optically ideal position relative to the reflector sections 122 and 123. Accordingly, in the lighting device 1 according to the present embodiment employed as the vehicle fog lamp, the illumination light can be sharply projected in an illumination pattern preferable for the fog lamp, in which light is distributed at and below the horizontal position, as shown in FIG. 13A, for example. The focal points F1 and F2 may be set to the vicinity of the light emitting section 12a of each of the LEDs 12 depending on the shapes of the reflection surfaces 122c and 123c.

In this case, since the antireflection layer 125 is formed on each of the incident surfaces 121a, 122a and 123a, the occurrence of stray light or the like due to the Fresnel reflection component can be appropriately prevented. Accordingly, a bright line can be prevented from being produced above and below the illumination pattern by the stray light, thereby achieving a light distribution pattern having high visibility.

Since the antireflection layer 125 is formed, incident efficiency from the LEDs 12 to the optical member 120 is also improved, thereby improving luminance of the illumination pattern.

Visible light reflected at the incident surfaces 121a, 122a and 123a is partially absorbed by the LED substrate 11 or the like and converted to heat. By preventing the Fresnel reflection by the antireflection layer 125, returning light to the LED substrate 11 or the like by reflection can be reduced. Thus, even when the LEDs 12 have higher output, such problems that the LED substrate 11 is excessively heated to damage the optical member 120 or reduce light emission efficiency of the LEDs 12 can be prevented.

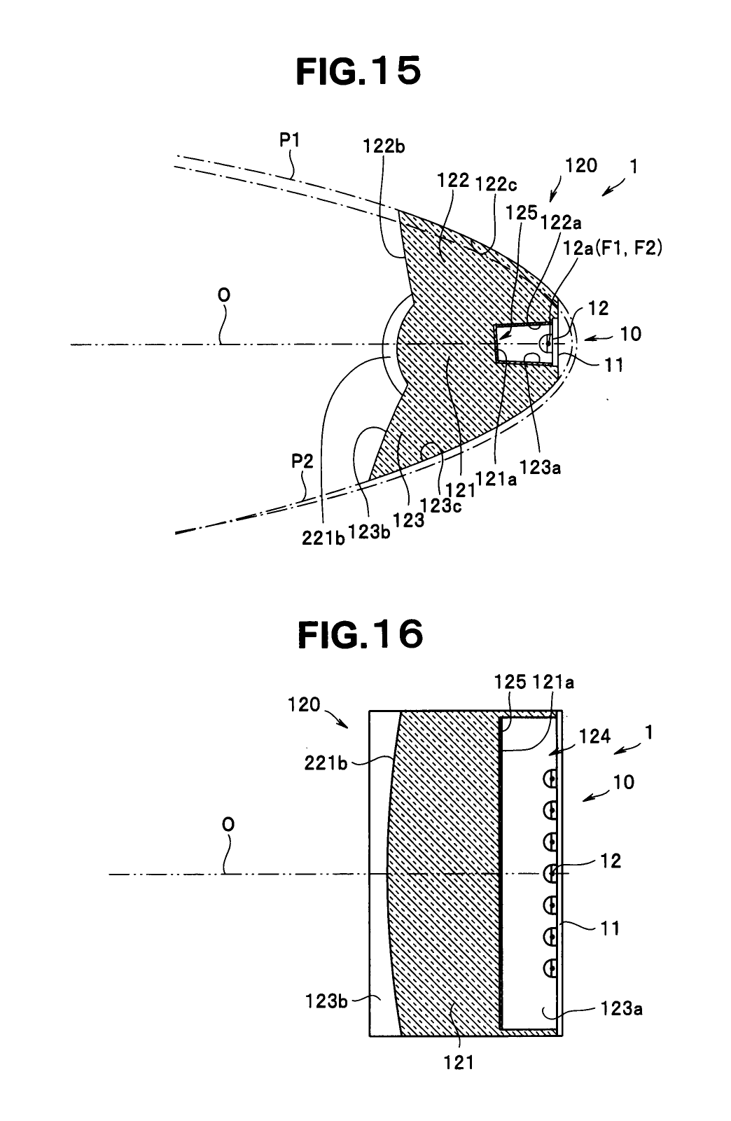

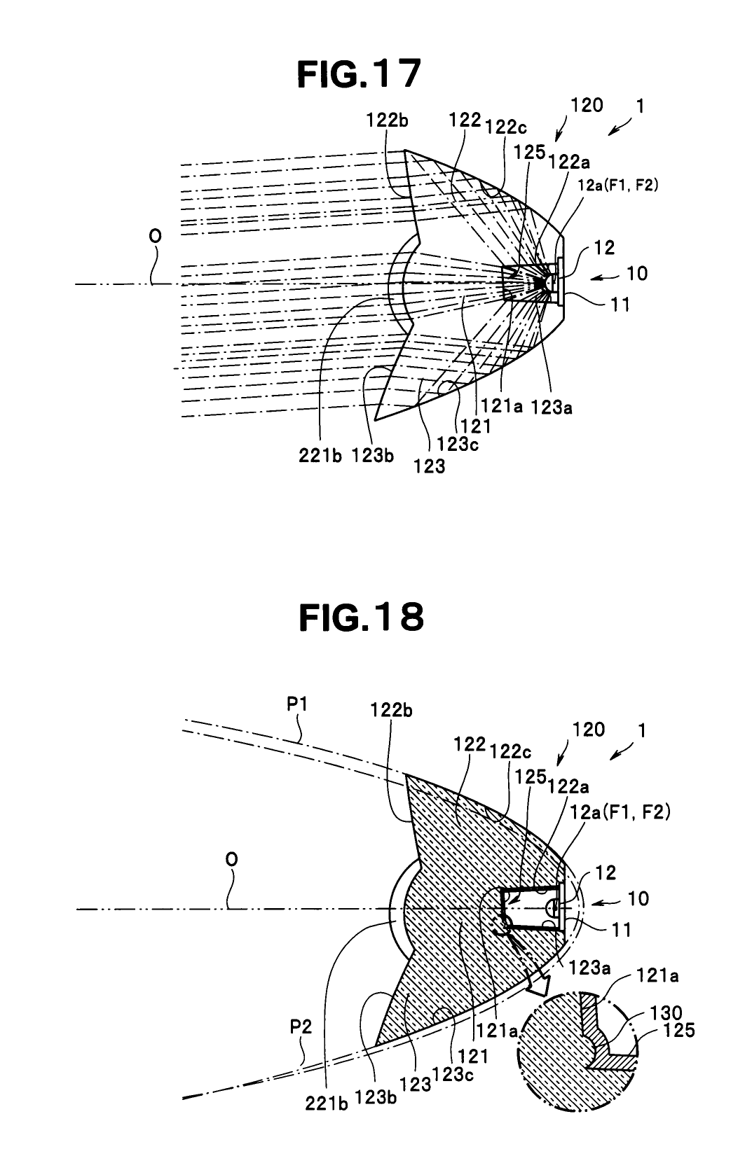

Next, FIGS. 14 to 18 are related to a third embodiment of the present invention. FIG. 14 is an exploded perspective view schematically illustrating a configuration of a vehicle lighting device. FIG. 15 is a vertical sectional view of a portion of the vehicle lighting device. FIG. 16 is a horizontal sectional view of the portion of the vehicle lighting device. FIG. 17 is an explanatory view illustrating a simulation result of behavior of light that enters the optical member. FIG. 18 is a vertical sectional view of the portion illustrating a modification of the vehicle lighting device. In the present embodiment, the lens section 121 mainly has a different configuration from that of the aforementioned second embodiment. The same or similar components as those of the second embodiment other than the lens section 121 are assigned the same reference numerals, and the description thereof is omitted.

As shown in FIGS. 14 to 16, in the present embodiment, an emission surface 221b of the lens section 121 is a curved surface having predetermined curvatures not only in a vertical direction but also in a horizontal direction. To be more specific, the emission surface 221b according to the present embodiment is a long toroidal surface having a relatively large curvature in the vertical direction and a relatively small curvature in the horizontal direction, for example. The curvatures of the emission surface 221b in the vertical direction and the horizontal direction are respectively optimized based on experiments, simulations or the like. Since the emission surface 221b has the curvature in the horizontal direction, light which is radiated at a wide angle in the horizontal direction from each of the LEDs 12 to enter a lower portion of the incident surface 121a can be also effectively controlled by the lens section 121. That is, as shown in FIG. 17, for example, the light radiated at a wide angle in the horizontal direction from each of the LEDs 12 to enter the lower portion of the incident surface 121a can be emitted from the emission surface 221b without being directed upward relative to the horizontal direction.

With the present embodiment, substantially same effects as those of the aforementioned second embodiment can be achieved. In this case, since the light radiated at a wide angle in the horizontal direction from each of the LEDs 12 to enter the lower portion of the incident surface 121a can be effectively emitted as the illumination light from the emission surface 221b without being guided to outside the illumination light path, light use efficiency can be improved.

The refraction section 130 described in the aforementioned second embodiment and the emission surface 221b described in the aforementioned third embodiment may be combined to constitute the lens section 121 as shown in FIG. 18, for example. With the configuration, an illumination pattern of desired light distribution required in a fog lamp or the like can be more appropriately projected.

Although the example in which the present invention is applied to the fog lamp is described in the aforementioned respective embodiments, the present invention is not limited thereto. For example, the present invention may be also applied to a headlight or the like.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A vehicle lighting device comprising a light source whose optical axis is set in a horizontal direction, and an optical member configured to control emitted light from the light source,
wherein the optical member comprises:
a lens section provided on the optical axis of the light source and configured to emit incident light from the light source by changing the incident light by refraction;
an upper reflector section integrated with the lens section and made of a light transmissive material, and configured to emit incident light from the light source by totally reflecting the incident light at an upper reflection surface formed above the lens section; and
a lower reflector section integrated with the lens section and made of a light transmissive material, and configured to emit incident light from the light source by totally reflecting the incident light at a lower reflection surface formed below the lens section,
an optical axis of the lens section being inclined downward relative to the horizontal direction from the light source,
the upper reflection surface being an aspheric surface with a focal point positioned at the light source or vicinity of the light source, and
the lower reflection surface being an aspheric surface different from the upper reflection surface with a focal point positioned at the light source or vicinity of the light source.

2. The vehicle lighting device according to claim 1,
wherein a refraction section configured to refract the incident light from the light source downward and guide the incident light to outside an illumination light path is formed at a lower portion of an incident surface of the lens section.

3. The vehicle lighting device according to claim 1,
wherein an emission surface of the lens section is a curved surface having curvatures in a vertical direction and in the horizontal direction.

4. The vehicle lighting device according to claim 1,
wherein a refraction section configured to refract the incident light from the light source downward and guide the incident light to outside an illumination light path is formed at a lower portion of an incident surface of the lens section, and
an emission surface of the lens section is a curved surface having curvatures in a vertical direction and in the horizontal direction.

5. The vehicle lighting device according to claim 1,
wherein an antireflection layer is formed on an incident surface of the optical member through which the emitted light from the light source is introduced.
